(19) United States
(12) Patent Application Publication
(10) Pub. No.: US 2019/0191527 A1
(43) Pub. Date: Jun. 20, 2019

(54) DRIVER CIRCUIT USABLE FOR SUPPLYING PULSED LIGHT SOURCE

(71) Applicant: TetraVue, Inc., Vista, CA (US)

(72) Inventors: Peter J. Rock, Poway, CA (US); Charles Stewart Tuvey, San Diego, CA (US)

(21) Appl. No.: 15/845,719

(22) Filed: Dec. 18, 2017

(51) Int. Cl. H05B 37/02; H05B 33/08; F21V 23/00

(52) U.S. Cl. CPC H05B 37/0209; F21Y 2115/10; F21V 23/005; H05B 33/0818

(57) ABSTRACT

A circuit and method for providing pulsed power to a solid-state light emitting device are disclosed. The circuit includes multiple electrical components and at least one conductor connecting the components. The conductor is configured to carry current to power the solid-state light emitting device. The circuit may be used to generate very short, high peak power pulses, and thus, the conductor is further configured to reduce inductance in the circuit so that short pulses of high current flow may be achieved. Other components and the physical layout of the circuit may also be configured to reduce inductance of the circuit. The circuit may include a MOS gated thyristor (MGT) to switch the current flow.

### TECHNICAL FIELD

This disclosure generally relates to power conversion for pulsed applications, and more particularly, to pulsed light sources and their driver circuits.

### BACKGROUND

Pulsed driver circuits are used to generate pulses of current, often into solid-state light emitting devices, such as light emitting diodes (LEDs) or laser diodes. The light output from the emitting device may be used for various purposes, such as pumping lasers or timed illumination.

In pulsed driver circuits, the rise and fall times of the drive current should be very short for certain applications. The current rise and fall times are limited by the inductance of the light emitting device, wiring, and electrical components in a driver circuit. In some known drivers, slow rise times are improved by increasing the driving voltage to help overcome the reactive load due to the inductance of the circuit, light emitting device, wiring, and driver components. Unfortunately, in pulsed current sources, additional voltage may result in greater power dissipation during operation. Also, using high voltages generally requires larger, more bulky and more expensive drive components that may cause an increase in power loss and a subsequent decrease in efficiency. In some applications, large, expensive drive components are undesirable or unsuitable. Thus, there is a need for an improved compact, high-energy, high efficiency, pulsed driver circuit and light source.

### SUMMARY

A circuit for providing pulsed power to a solid-state light emitting device is disclosed. The circuit includes multiple electrical components and at least one conductor connecting the components. The conductor is configured to carry current to power the solid-state light emitting device. The conductor is further configured to reduce inductance in the circuit so that very short, high peak power pulses of high current flow may be achieved. Other components and the physical layout of the circuit may also be configured to reduce inductance of the circuit.

This disclosure also describes another circuit for providing pulsed power to a solid-state light emitting device, where the circuit includes a planar substrate having a first side and an opposing second side. At least one electrical component is mounted on the first side of the substrate, and at least one electrical component is mounted on the second side of the substrate. One or more conductors, connecting the electrical components on both sides of the substrate, are configured to carry current to power the solid-state light emitting device. The conductors include a first portion located on or over the first side of the substrate and a second portion located on or over the second side of the substrate. The first portion may be configured to carry the current in a first direction, and the second portion may be configured to carry the current in a second direction opposite to the first direction so as to cancel the magnetic field generated by the rapidly changing current caused by the fast pulse rise/fall time in the first portion and thereby reduce the inductance of the circuit carrying the current.

This disclosure also describes a circuit for emitting pulsed light. The circuit includes a planar substrate having a first side opposing a second side; one or more capacitors mounted on the first side of the substrate; one or more diodes mounted on the first side of the substrate; a first conductor connecting the capacitors and the diodes, the first conductor configured to carry current to power a solid-state light source; the solid-state light source mounted on either the first side or second side of the substrate; a second conductor configured to carry the current between the diodes and the a solid-state light source; a resistor block mounted on the second side of the substrate; a third conductor configured to carry the current between the solid-state light source and the resistor block; a switch mounted on the second side of the substrate for selectively allowing the current to flow; a fourth conductor configured to carry the current between the resistor block and the switch; and a fifth conductor configured to carry the current between the switch and the capacitors.

This disclosure also describes a method of generating pulses of current for driving a solid-state light emitting device. The method includes providing at least one capacitor as part of a circuit for providing current to the solid-state light emitting device, and providing at least one electrical conductor connecting the capacitor to one or more other components of the circuit. The conductor is configured to carry the current for powering the solid-state light emitting device and to reduce inductance of the circuit. A switch is provided for controlling flow of the current through the circuit. The switch may be momentarily closed so that the current flows through the solid-state light emitting device.

The foregoing summary does not define the limits of the appended claims. Other aspects, embodiments, features, and advantages will be or will become apparent to one with skill in the art upon examination of the following figures and detailed description. It is intended that all such additional features, aspects, and advantages be included within this description and be protected by the accompanying claims.

### BRIEF DESCRIPTION OF DRAWINGS

It is to be understood that the drawings are solely for purpose of illustration and do not define the limits of the appended claims. Furthermore, the components in the figures are not necessarily to scale. In the figures, like reference numerals designate corresponding parts throughout the different views.

FIG. 1 is a schematic diagram of an exemplary circuit for producing light pulses.

FIG. 2 is a schematic diagram illustrating a second exemplary circuit for producing light pulses.

FIG. 3 is a schematic diagram illustrating a third exemplary circuit for producing light pulses.

FIG. 4 is a side cross-sectional schematic view illustrating a first exemplary component configuration for a pulsed light circuit.

FIG. 5 is a side cross-sectional schematic view illustrating a second exemplary component configuration for a pulsed light circuit.

FIG. 6 is a side cross-sectional schematic view illustrating a third exemplary component configuration for a hermetically packaged pulsed light circuit.

FIG. 7 is a side cross-sectional schematic view illustrating a fourth exemplary component configuration for a pulsed light circuit.

FIG. 8 is a side cross-sectional schematic view illustrating a fifth exemplary component configuration for a hermetically packaged pulsed light circuit.

FIG. 9 is a top perspective schematic view of a sixth exemplary component configuration for a pulsed light circuit.

FIG. 10 is a bottom perspective schematic view of the sixth exemplary component configuration for a pulsed light circuit.

FIG. 11 is a side cross-sectional schematic view illustrating of the sixth exemplary component configuration for a pulsed light circuit.

### DETAILED DESCRIPTION

The following detailed description, which references to and incorporates the drawings, describes and illustrates one or more examples of a pulsed, solid-state light emitting apparatus that includes driver circuitry. These examples, offered not to limit but only to exemplify and teach embodiments of the invention(s), are shown and described in sufficient detail to enable those skilled in the art to practice what is claimed. Thus, where appropriate to avoid obscuring what is claimed, the description may omit certain information known to those of skill in the art. The disclosures herein are examples that should not be read to unduly limit the scope of any patent claims that may eventual be granted based on this application.

The word “exemplary” is used throughout this application to mean “serving as an example, instance, or illustration.” Any system, method, apparatus, device, technique, feature or the like described herein as “exemplary” is not necessarily to be construed as preferred or advantageous over other features.

As used in this specification and the appended claims, the singular forms “a,” “an,” and “the” include plural referents unless the content clearly dictates otherwise.

Although any methods and circuits similar or equivalent to those described herein can be used, specific examples of appropriate circuits and methods are described herein.

Also, the use of “or” means “and/or” unless stated otherwise. Similarly, “comprise,” “comprises,” “comprising” “include,” “includes,” and “including” are interchangeable and not intended to be limiting.

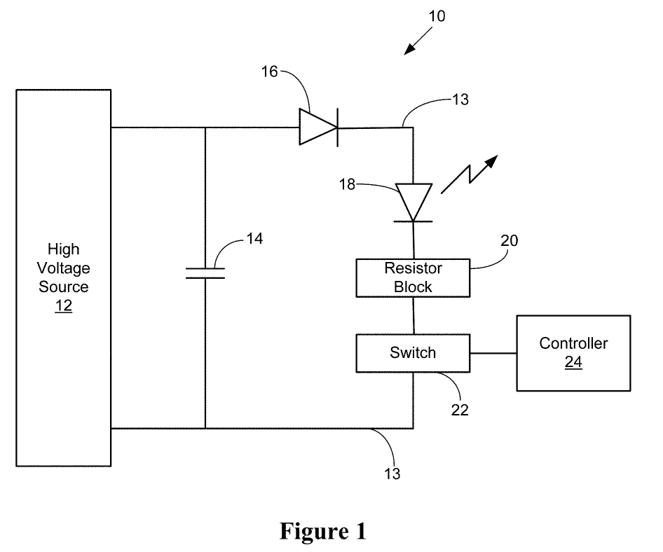

FIG. 1 is a schematic diagram of an exemplary driver circuit 10 for producing light pulses. The circuit 10 is designed and configured to reduce inductance in the circuit 10 so that very short, high peak power pulses of high current may flow through a light emitting device 18. The circuit 10 includes a high voltage source 12, one or more storage capacitors 14, one or more diodes 16, the light emitting device 18, an optional resistor block 20 having one or more resistors, a switch 22 for selectively activating the current flow through the circuit 10, and a controller 24 configured to control operation of the switch 22. A circuit path 13, having conductors for carrying the current that powers the light emitting device 18, connects the electrical components 12, 14, 16, 18, 20, 22 together. The circuit path 13, components and/or physical layout of the circuit 10 may be specifically configured to reduce inductance of the pulsed current path in the circuit 10.

In operation, the high voltage source 12 supplies a charging current and applies voltage across the capacitor 14 and the parallel circuit branch containing components 16, 18, 20 and 22. The voltage provided by the source 12 may be a direct current voltage in the tens of volts to kilovolt range. The voltage source 12 may be a commercially available power supply. With the switch 22 open, current does not flow through the circuit branch supplying the light emitting device 18. To generate a light pulse from the emitting device 18, the controller 24 applies a control signal to the switch 22 that momentarily closes the switch 22, permitting current to flow from the capacitor 14 and source 12 through the circuit branch that includes the light emitting device 18.

The controller 24 may set the timing, timing sequence, duty cycle, period and/or duration of the switch activation to control the nature of the current pulse, and thus, the characteristics of the emitted light pulse. The controller 24 may do this by controlling the timing characteristics of the control signal to the switch 22. The controller 24 may set the timing, duty cycle, period, and duration of the current pulse to any suitable values, depending on the application of the circuit 10. For example, in some applications, controller 24 may activate the switch 22 so that the duration of the light pulse (which may be correlated with the switch closed period in some configurations of the circuit) may be between 10 and 500 ns and the light pulse frequency may be between 1 and 10,000 Hz, depending on circuit design. The controller 24 may be programmed to generate any suitable number of pulses, for example, it may be configured to activate the switch 22 to produce a single pulse. Alternatively, it may cause the switch 22 to generate a burst of pulses, for example a series of 2 to 100 pulses, or it may be programmed to cause the switch 22 to generate a continuous series of pulses having a predefined duty cycle.

The controller 24 may have a fixed number of settings, e.g., six different settings, where each setting produces a switch control signal with distinct timing characteristics that generate a specified type of light pulse(s) with particular timing characteristics. The controller 24 may also be a programmable device that permits a user to select pulse timing characteristics according to the application at hand.

The controller 24 may be implemented in hardware, software/firmware executed by a processor, or any suitable combination thereof. If implemented in software, the functions of the controller 24 may be stored as one or more instructions or code on a computer-readable medium (e.g., memory chip) and executed by a hardware-based processing unit (e.g., microprocessor). Computer-readable media may include any non-transient computer-readable storage media, including data storage media, which may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, programmable ROM, EEPROM, CD-ROM or other optical disc storage, magnetic disk storage, or other magnetic storage devices, flash memory, or any other medium that can be used to store desired program code in the form of instructions or data structures and that can be accessed by a computer. Disk and disc, as used herein, includes compact disc (CD), laser disc, optical disc, digital versatile disc (DVD), floppy disk and blu-ray disc, where disks usually reproduce data magnetically, while discs reproduce data optically with lasers. Combinations of the above should also be included within the scope of computer-readable media.

The controller 24 may include one or more processors for executing instructions or code, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits, including logic circuits and/or logic elements.

The switch 22 may be any suitable device for switching the current flow on in response to control signals from the controller 24, with the required timing (e.g., turn-on timing) and pulsed current amperage. For example, the switch 22 may be one or more MOSFETs, thyristors, MOS gated thyristors (MGTs) or any suitable combination of the foregoing. The switch 22 may be a device that is capable of handling pulsed high currents.

The resistor block 20 may include multiple, low impedance resistors connected in parallel with one another. The resistor block 20 provides circuit damping for controlling the “Q” of the current pulse in the circuit 10. It also may serve as a current viewing resistor. In some configurations of the circuit 10, the resistor block 20 is omitted. Alternatively/additionally, parasitic resistance of circuit 10 may be used instead of the resistor block 20 or in combination with the resistor block 20.

The diode 16 may be any suitable type of diode(s), for example, one or more Schottky SiC diodes connected together in parallel. The diode 16 is a commutating diode that protects against reverse bias of the laser diodes.

The capacitor 14 may be any suitable capacitor for supplying electrical energy to the light emitting device 18 at the desired current and pulsed light timing. For example, one or more non-polarized ceramic capacitors may be used. The capacitor(s) may be low ESR (equivalent series resistance), NPO capacitors. Although FIG. 1 shows only one capacitor 14, multiple capacitors may be connected together in parallel to substitute for the single capacitor, increasing the capacitance of the circuit 10.

The high-current switched circuit 10 is useful for any semiconductor, electrically pumped, light emitting devices containing an optically active medium where gain is generated by an electrical current. Accordingly, the light emitting device 18 may be a solid-state component such as a laser diode, a light emitting diode (LED), a vertical surface cavity emitting laser (VCSEL), an edge emitting laser diode, one or more bars of laser diodes, one or more arrays of VCSELs, one or more arrays of LEDs, and any suitable combination of the foregoing.

Edge emitting laser devices, whether arranged in bars, fractional bars, multiple bars, or single emitters may be used as the light emitting device 18. Arrays of bars may be arranged electrically in series or parallel. In edge emission diode lasers, the optical cavity is formed by either coated or uncoated end facets. The optical mode is confined by a waveguide structure in both dimensions transverse to the direction of light propagation.

Any suitable laser bar may be used having any suitable number of emitters and any suitable frequency band of emitted light. For example, centimeter laser bars utilizing both single and multiple quantum well epitaxial structures, with 30-60 emitters per bar, may be used, with the emitted light frequency band centered at 808 nM. Other frequencies in the visible, infrared or ultraviolet ranges may be used. The bars may be stacked bar-to bar with the metallization layer in contact with the p-side making electrical contact with the metallization layer in contact with the n-side of the adjacent device. Alternatively, bars may be arranged in series where an electrically conductive submount is between each bar in the stack (electrically in series). Also, single bars or stacks of bars may be driven in parallel.

Alternatively/additionally, vertical surface cavity emitting laser (VCSEL) device arrays may be used as the light emitting device 18. In a VCSEL device, the laser mode propagates normal to the wafer surface. The laser cavity is formed by two distributed Bragg reflector mirrors on either side of the optically active region. In contrast to edge-emission laser devices, these mirrors are designed fabricated into the epitaxial structure. In the high peak current applications, single or multiple quantum well structures in the active regions may be used.

The driver circuit 10 may drive a single laser, but it may also drive arrays of lasers, either edge emitters, VCSELs, or arrays of LEDs. The lasers may be high peak power diodes, for example, between 200-500 W peak power.

Alternatively/additionally, light emitting diodes (LEDs) may be used as the light emitting device 18. LEDs use an optically active medium without cavity mirrors. They have different gain properties and spectral properties than semiconductor laser devices, but arrays of LEDs may be electrically pumped using the high current switch circuit 10. Arrays of LEDs may be arranged electrically in series or parallel depending on design requirements.

The epitaxy and bar designs of laser diodes or LEDs may be optimized specifically for low duty cycle and high current density operation. For example, laser diodes' or LEDs' the output coupler reflectivity may be decreased to leverage increased optical gain using high current densities. Also, waveguide dimensions may be increased in edge emission devices to lower fluence on diode facets.

The light pulse emitted by the device 18 may be any suitable electromagnetic signal having an appropriate frequency bandwidth and spectral distribution. For example, the emitted light pulse may be in the ultraviolet, visible or infrared portions of the spectrum. Also, the timing and duration of the emitted light pulses may depend on the application. For example, each light pulse may have a relatively short duration of any value between 10-500 ns. Other light pulse durations may be used depending on the application, such as longer pulses in the hundreds of nanoseconds or microsecond range. For some imaging applications, a pulse width of 10 s of microseconds may be used. For some applications the pulse duration may be even longer, on the order of a frame period, e.g., 33 ms (the standard frame time of a camera operating at 30 frames/second).

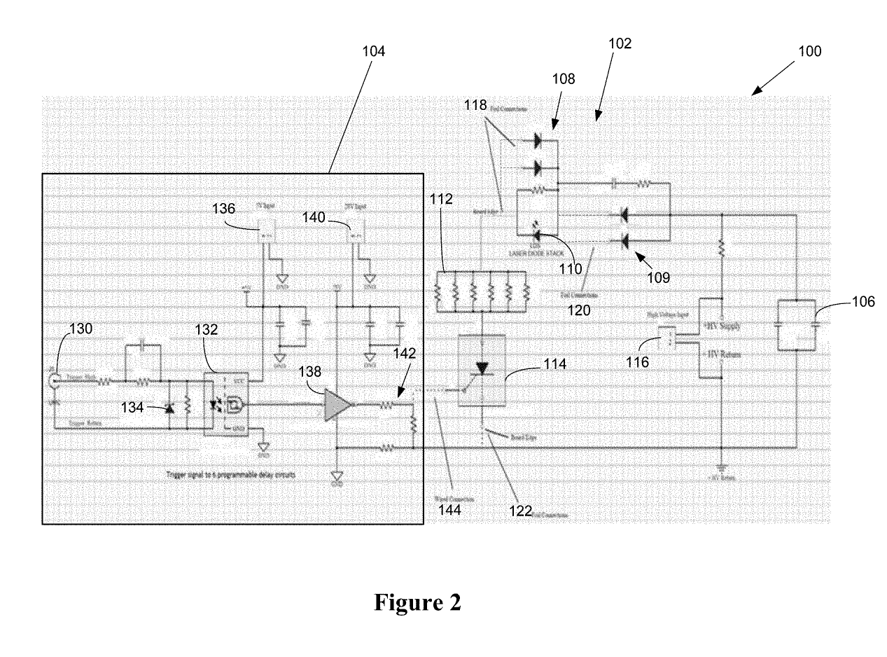

FIG. 2 is an electrical schematic diagram illustrating a second exemplary driver circuit 100 for producing light pulses. The circuit 100 may implement elements of the circuit 10 shown in FIG. 1. The circuit 100 includes a power conversion circuit 102 and a control signal conditioning circuit 104. The power conversion circuit 102 includes a pair of energy storage capacitors 106 connected in parallel, four diodes 108, each may be an SiC Schottky diode, a laser diode stack (LDS) 110 emitting light at a desired frequency band, as the light emitting device 18, a resistor block 112 that may include, for example, six metal foil ¼ Ohm resistors connected in parallel, a MOS gated thyristor (MGT) switch 114, and a high voltage power supply 116. The MGT switch 114 may be a commercially available MGT, such as part number MMJX1H4ON150 from IXYS Corporation. The operation of the power conversion circuit 102 and LDS 110 may be the same as that described in connection with FIG. 1.

The resistors of the resistor block 112 may be any suitable value depending on the desired “Q” of the current pulse. In some configurations, the resistor block may be omitted. In other configurations, parasitic resistance of the circuit 102 may be used instead of or in combination with the resistor block 112.

The control signal conditioning circuit 104 includes a control trigger signal input 130 configured to receive a control signal from a controller, such as controller 24. Conditioning circuitry 134, which includes a clamping diode, provides the trigger signal to a photocoupler 132. The photocoupler may be a commercially available device, such as part number TLP2367 from Toshiba Corporation. A first low voltage source 136 supplies the photocoupler 132. The trigger output of the photocoupler 132 is provided to an inverting gate driver 138. The inverting gate driver 138 is supplied by a second low voltage supply 140. The control trigger signal output from the inverting gate driver 138 then passes through a gate isolation resistor 142, which then passes the buffered control trigger signal (gate pulse signal) to the gate input of the switch 114.

The power conversion circuit 102 includes a foil conductor 118 connecting the diodes 108 and LDS 110 to the resistor block 112. It also includes another foil conductor 120 connecting the diodes 109 and LDS 110. The diodes 108, 109 may be commutating diodes that protect the LDS 110 from a reverse voltage that may occur at switch turn off. The circuit 102 also includes a foil conductor 122 connecting the MGT switch cathode to the current return of the capacitors 106 and high voltage supply 116. A flat wire conductor 144 may be used to carry the control trigger signal between the control circuit 104 and the gate of the MGT switch 114. The foils and wire 118, 120, 122, 144 may be copper, silver, gold, silver-plated copper, aluminum, or any suitable combination of the foregoing. The foils and wire may be configured to reduce inductance in the power conversion circuit 102. For example, they can be made thin (e.g., five skin depths or less, which depth may be determined based on the resonant frequency of the power conversion circuit 102 and the permeability of the conductor material) and relatively wide to reduce inductance. Also, they may be placed in the circuit 100 so that the magnetic fields induced by current flowing through the conductors counteract one another to the greatest extent possible in order to reduce the inductive reactance and thus reduce the peak voltage requirement of the circuit 102. Additionally, other components and conductors in the circuit 100 may be likewise configured to reduce inductance.

The LDS 110 may be any suitable laser diode stack operating at a desired wavelength of emitted light, for example, infrared, visible or ultraviolet.

The power conversion circuit 102 may be resonant and may have a self-resonant frequency that is a function of the capacitance of the energy supply capacitors 106 and the parasitic inductance of the circuit 102. The current pulse width may be determined by the resonant frequency of the circuit 102. Thus, the current pulse duration of the circuit 102 may be tailored to specific values by designing the circuit 102 to have a specific resonant frequency based on the capacitance and inductance in the circuit 102. Generally, the current pulse width generated by the circuit 102 is about one half a cycle at the resonant frequency. Thus, for a pulse width in the range of about 10 ns to 500 ns, the circuit resonant frequency would be in the range of about 1 MHz to 50 MHz. For example, the resonant frequency may be about 4.166 MHz.

In operation, a controller, e.g., controller 24, provides a trigger signal at the control trigger signal input 130. In response to this trigger signal, the control signal conditioning circuit 104 outputs the gate pulse signal from resistor 142 that is received by the gate of the MGT switch 114. The gate pulse signal may have a duration shorter than one-half a cycle of the circuit resonant frequency. The gate pulse signal turns on the MGT switch 114, causing the current to flow from the capacitors 116 through the circuit 102. The MGT switch 114 self-commutates at zero current. Thus, the MGT switch 114 turns itself off when the current pulse flowing through it drops to zero, which may be at or near one-half a cycle of the circuit resonant frequency.

All of the components shown in FIG. 2 may be surface mounted components and the semiconductor components and/or other electrical components may be unpackaged, bare die devices that can be flip-chip mounted, directly wire bonded to a circuit board substrate, or bonded to conductive metal foil. The use of unpackaged components may reduce the inductance of the circuit 102.

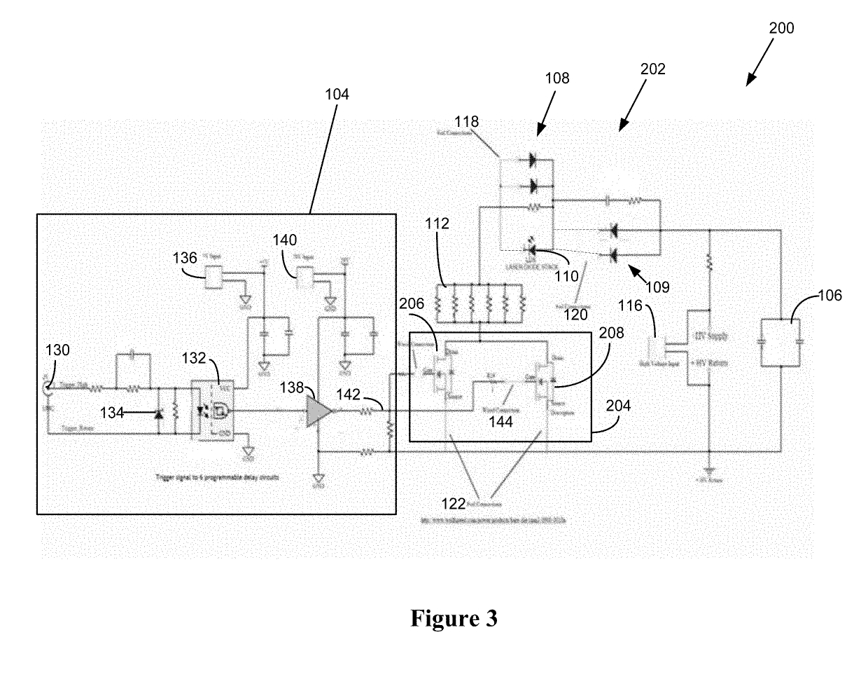

FIG. 3 is a schematic diagram illustrating a third exemplary driver circuit 200 for producing light pulses. The circuit 200 may implement elements of the circuit 10 shown in FIG. 1. The circuit 200 include a power conversion circuit 202 and the control signal conditioning circuit 104 shown in FIG. 2. The power conversion circuit 202 includes many of the same components described in connection with FIG. 2, but substitutes a MOSFET type switch 204 for the MGT switch 114. The MOF SET type switch 204 may include any suitable number of MOSFETs, for example, FIG. 3 shows two MOSFETs 206, 208 connected in parallel to provide the switch functionality of the circuit 200.

In operation, a controller, e.g., controller 24, provides a trigger pulse signal at the control trigger signal input 130. In response to this trigger pulse signal, the control signal conditioning circuit 104 outputs the gate pulse signal from resistor 142 that is received by the gate of each MOSFET switch 206, 208. The controller may set the duration of the trigger pulse signal so as to control the amount of time the MOSFET switches 206, 208 are turned on. The gate pulse signal in a high state turns on the MOSFET switches 206, 208, causing the current to flow from the capacitors 116 through circuit 202 while the gate pulse is in a high state. When the gate pulse signal returns to a low state, the MOSFET switches 206, 208 turn off, which may cause the capacitor current to stop flowing. In this configuration, the duration of the trigger pulse signal from the controller may be used to control the duration of the current pulse delivered by the circuit 202, and the current pulse width does not necessarily depend on the resonant frequency of the circuit 202.

All of the components shown in FIG. 3 may be surface mount components and the semiconductor components and/or other electrical components may be unpackaged, bare die devices that can be flip-chip mounted, directly wire bonded to a circuit board substrate, or bonded to conductive metal foil. The use of unpackaged components may reduce the inductance of the circuit.

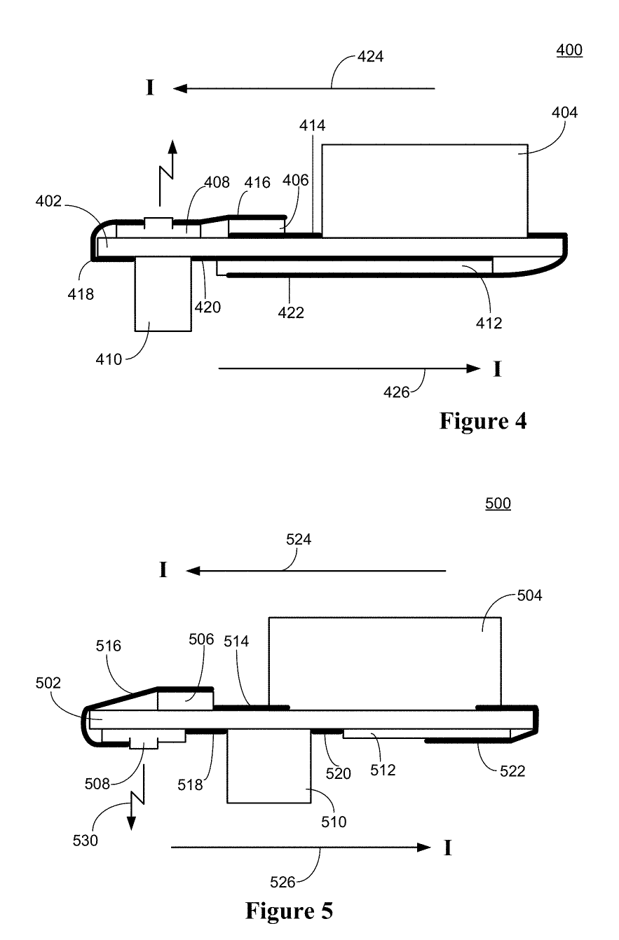

FIG. 4 is a side cross-sectional schematic view illustrating a first exemplary component configuration for a pulsed light circuit 400. This configuration illustrates an example physical layout for any one of the circuits 10, 100, and 200 that is designed to reduce inductance in the driver circuit supplying power to the light emitting device. The circuit 400 may implement elements of the circuits 10, 100, and 200 disclosed herein, respectively, and operate as described above in connection with those circuits.

As shown in FIG. 4, the circuit 400 includes a generally planar substrate 402 having a top side and a bottom side. One or more energy supply capacitors 404 are mounted to the top side of the substrate 402, one or more diodes 406 are also mounted to the top side of the substrate 402, and a light emitting device 408, such as an array of edge emitting laser diodes or LEDs, VCSELs, or the like, is also mounted to the top side of the substrate 402 and generally emits light pulses 430 in a normal direction relative to the substrate 402. A resistor block 410 and a solid-state switch 412 are mounted to the bottom side of the substrate 402. The components 404, 406, 410 and 412 can be the same as those described in connection with FIGS. 1, 2, and 3, respectively, with the light emitting device 408 being a vertically-oriented emitting device, such as an edge emitting laser diode configured to emit normal to the substrate, or a bar of such diodes, one or more vertically configured LEDs, a VCSEL or an array of VCSELs, described earlier.

A conductor 414 connects the capacitor(s) 404 to the diode(s) 406. The conductor 414 can be a metal trace or layer on or within the substrate 402. Conductor 416 connects the diode(s) 406 to the light emitting device 408. The conductor 416 can be a metal foil, as described earlier herein, bonded to the diodes 406 and the light emitting device 408. Conductor 418, which can be a metal foil as described earlier herein, wraps around the edge of the substrate 402 to connect the light emitting device 408 to the resistor block 410. Conductor 420 connects the resistor block 410 to the switch 412. The conductor 420 can be a metal trace or layer on or within the substrate 402. Conductor 422, which can be a metal foil as described earlier herein, wraps around the other edge of the substrate 402 to connect the switch 412 to the capacitors 404. The conductors 414-422 may be relatively thin and wide to reduce inductance. For example, one or more of the conductors 414-422 may be five skin depths or less in thickness. The skin depth may be determined based on the self-resonant frequency of the circuit and relative permeability of the conductor. For example, for a copper conductor with a relative permeability of about one and a circuit resonant frequency of about 4.166 MHz, the skin effect depth is about 31.9 μm. Thus, five skin depths is about 159.5 μm in this case.

The conductors 414-422 form a circuit path with the components 404-412 for carrying current to power the solid-state light emitting device 408. For pulsed applications, the peak currents for the circuit 100 can be high, e.g., 4 kiloamps (kA) or more, such as 10 kA or more. To reduce inductance in the power conversion circuit path, the components 404-412 and conductors 414-422 are arranged so that the pulsed current flow 424 on the top side of the substrate 402 generally goes in a first direction (to the left in the example shown in FIG. 4), and current flow 426 on the bottom side of the substrate 402 generally goes in a second direction that is opposite to the flow on the top side of the substrate (to the right in the example shown in FIG. 4). By having currents flowing in opposite directions in this arrangement, the magnetic fields generated by changes in the current flow may cancel each other to some extent, thus reducing inductance in the circuit.

Additionally or alternatively, one or more of the conductors 414-422 may be a stripline formed within the substrate 402, i.e., a conductor sandwiched within a dielectric between two ground planes of the substrate 402, or a microstrip, i.e., a conductor separated from a ground plane by a dielectric layer included in the substrate 402.

The substrate 402 may be a co-fired ceramic substrate, for example, a high temperature co-fired ceramic (HTCC) substrate. The thickness of the substrate 402 may be kept relatively thin to reduce inductance. For example, the thickness of the substrate 402 may be 4 mils or less. The substrate 402 may have conductive layers formed only along its surfaces. Alternatively, the substrate 402 may be a multilayer substrate with conducting layers, such as metal layers, formed internally within itself and on its surfaces.

All of the components shown in FIG. 4 may be surface mount components and the semiconductor components and/or other electrical components may be unpackaged, bare die devices that can be flip-chip mounted, directly wire bonded to the substrate 402, or bonded to conductive foil. The use of unpackaged components may reduce the inductance of the circuit.

FIG. 5 is a side cross-sectional schematic view illustrating a second exemplary component configuration for a pulsed light circuit 500. This configuration illustrates another example physical layout for any one of the circuits 10, 100, and 200 that is designed to reduce inductance in the driver circuit supplying power to the light emitting device. The circuit 500 may implement elements of the circuits 10, 100, and 200 disclosed herein, respectively, and operate as described above in connection with those circuits.

As shown in FIG. 5, the circuit 500 includes a generally planar substrate 502 having a top side and a bottom side. One or more supply capacitors 504 are mounted to the top side of the substrate 502, and one or more diodes 506 are also mounted to the top side of the substrate 502. A light emitting device 508, such as a vertically-oriented emitting device, such as an edge emitting laser diode configured to emit generally normal to the substrate 502, or a bar of such diodes, one or more vertically configured LEDs, a VCSEL or an array of VCSELs, is mounted to the bottom side of the substrate 502 and generally emits light pulses 530 in a normal direction relative to the substrate 502. A resistor block 510 and a solid-state switch 512 are also mounted to the bottom side of the substrate 502. The components 504, 506, 510 and 512 can be the same as those described in connection with FIGS. 1, 2, and 3, respectively, with the light emitting device 508 being a vertical emitting device, such as an edge emitted laser diode or bar array of such diodes or LEDs that is oriented to emit generally normal to the substrate 502, or a VCSEL an array of VCSELs described earlier.

A conductor 514 connects the capacitor(s) 504 to the diode(s) 506. The conductor 514 can be a metal trace or layer on or within the substrate 502. Conductor 516 wraps around an edge of the substrate to connect the diode(s) 506 to the light emitting device 508. The conductor 516 can be a metal foil, as described earlier herein, bonded to the diodes 506 and the light emitting device 508. Conductor 518, which can be metal foil or metal trace or layer on or within the substrate 502, connects the light emitting device 508 to the resistor block 510. Conductor 520 connects the resistor block 510 to the switch 512. The conductor 520 can be a metal trace or layer on or within the substrate 502. Conductor 522, which can be a metal foil as described earlier herein, wraps around the other edge of the substrate 502 to connect the switch 512 to the capacitors 504. The conductors 514-522 may be relatively thin and wide to reduce inductance. For example, one or more of the conductors 514-522 may be five skin depths or less in thickness.

The conductors 514-522 form a circuit path with the components 504-512 for carrying current to power the solid-state light emitting device 508. For pulsed applications, using the circuit 100, the peak currents can be high, e.g., 4 kA or more, for example, 10 kA or more. To reduce inductance in the power conversion circuit path, the components 504-512 and conductors 514-522 are arranged so that power supply current flow 524 on the top side of the substrate 502 generally goes in a first direction (to the left in the example shown in FIG. 5), and current flow 526 on the bottom side of the substrate 502 generally goes in a second direction that is opposite to the flow on the top side of the substrate (to the right in the example shown in FIG. 5). By having currents flowing in opposite directions in this arrangement, the magnetic fields generated by changes in the current flow may cancel each other to some extent, thus reducing inductance in the circuit.

Additionally or alternatively, one or more of the conductors 514-522 may be a stripline formed within the substrate 502, i.e., a conductor sandwiched within a dielectric between two ground planes of the substrate 502, or a microstrip, i.e., a conductor separated from a ground plane by a dielectric layer included in the substrate 502.

The substrate 502 may be a co-fired ceramic substrate, for example, a high temperature co-fired ceramic (HTCC) substrate. The thickness of the substrate 502 may be kept relatively thin to reduce inductance. For example, the thickness of the substrate 502 may be 4 mils or less. The substrate 502 may have conductive layers formed only along its surfaces. Alternatively, the substrate 502 may be a multilayer substrate with conducting layers, such as metal layers, formed internally within itself and on its surfaces.

All of the components shown in FIG. 5 may be surface mount components and the semiconductor components and/or other electrical components may be unpackaged, bare die devices that can be flip-chip mounted, directly wire bonded to the substrate 502, or bonded to conductive foil. The use of unpackaged components may reduce the inductance of the circuit.

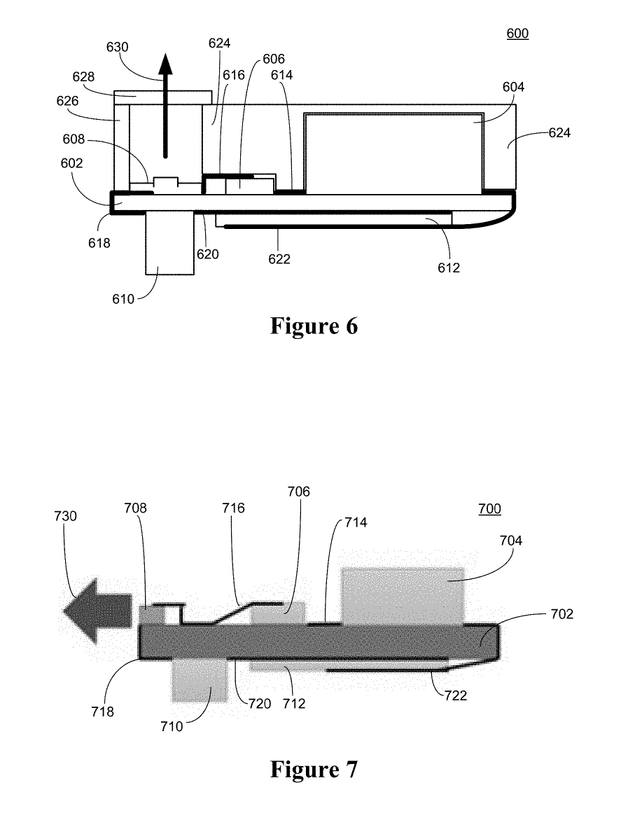

FIG. 6 is a side cross-sectional schematic view illustrating a third exemplary component configuration for a hermetically packaged pulsed light circuit 600. This configuration illustrates another example physical layout for any one of the circuits 10, 100, and 200 that is designed to reduce inductance in the driver circuit supplying power to the light emitting device. The circuit 600 may implement elements of the circuits 10, 100, and 200 disclosed herein, respectively, and operate as described above in connection with those circuits.

The components 602, 604, 606, 608, 610 and 612 can be the same as components 402, 404, 406, 408, 410 and 412, respectively, described in connection with FIG. 4, with light emitting device 608 emitting light pulses 630 during operation. The predominate difference between circuit 600 of FIG. 6 and circuit 400 of FIG. 4 is that circuit 600 includes an additional substrates 624, 626 and window 628 configured to provide a hermetic or non-hermetic package seal to protect the light emitting device 608. The optical window 628 is transparent in the spectral region of interest and may be fabricated from any suitable material meeting the optical and packaging system requirements. The window 628 may be plano, have positive or negative refractive power, or have a patterned diffuse or diffractive features. Reduced inductance may be achieved using the same techniques described in connection with FIG. 4.

In certain applications, such as automotive applications, water condensation on the on diode facets of the light emitting device 608 should be prevented over a large range of storage temperatures and humidity conditions. To ensure diode health over the automotive specification range, the circuit 600 includes a hermetic package to seal the light emitting device 608. The second substrate(s) 624, 626 plus the optical window 628 is placed over the components mounted on the top side of the substrate 602. This forms a hermetic seal over the light emitting device 608. In some configurations, the low inductance foil conductors 416, 418 are replaced with low inductance metal traces on the separate substrate(s) 624, 626, matched to make electrical connection to the components.

All of the components shown in FIG. 6 may be surface mount components and the semiconductor components and/or other electrical components may be unpackaged, bare die devices that can be flip-chip mounted, directly wire bonded to the substrate 602, or bonded to conductive foil. The use of unpackaged components may reduce the inductance of the circuit.

FIG. 7 is a side cross-sectional schematic view illustrating a fourth exemplary component configuration for a pulsed light circuit 700. This configuration illustrates another example physical layout for any one of the circuits 10, 100, and 200 that is designed to reduce inductance in the driver circuit supplying power to the light emitting device. The circuit 400 may implement elements of the circuits 10, 100, and 200 disclosed herein, respectively, and operate as described above in connection with those circuits.

The components 702, 704, 706, 710 and 712 can be the same as components 402, 404, 406, 410 and 412, respectively, described in connection with FIG. 4. And the conductors 714, 716, 718, 720, and 722 can be the same as conductors 414, 416, 418, 420, and 422, respectively, described in connection with FIG. 4. The predominate difference between circuit 700 of FIG. 7 and circuit 400 of FIG. 4 is that circuit 700 includes an edge emitting light device 708 that emits light pulses 730 in a generally horizontal direction relative to the substrate 702, instead of vertically, as shown in FIG. 4. Reduced inductance may be achieved using the same techniques described in connection with FIG. 4.

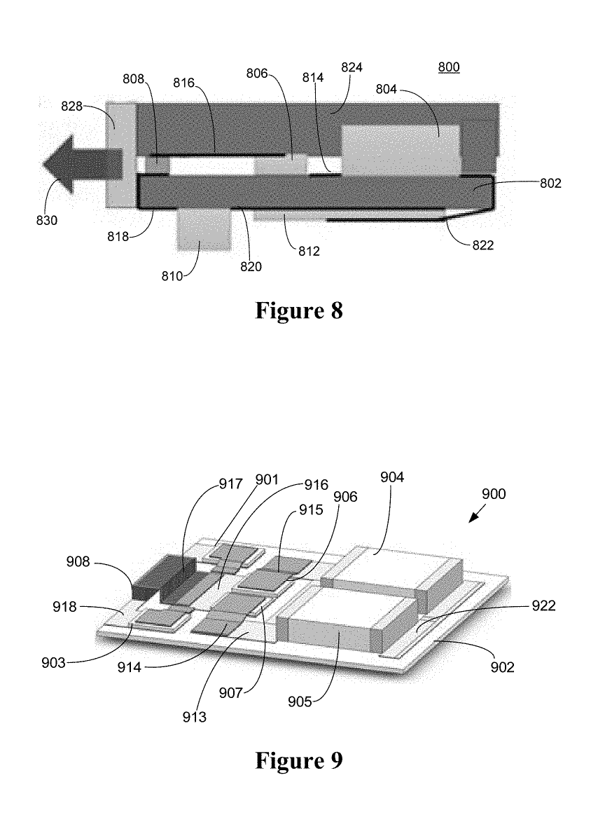

FIG. 8 is a side cross-sectional schematic view illustrating a fifth exemplary component configuration for a hermetically packaged pulsed light circuit 800. This configuration illustrates another example physical layout for any one of the circuits 10, 100, and 200 that is designed to reduce inductance in the driver circuit supplying power to the light emitting device. The circuit 800 may implement elements of the circuits 10, 100, and 200 disclosed herein, respectively, and operate as described above in connection with those circuits.

The components 802, 804, 806, 808, 810 and 812 can be the same as components 702, 704, 706, 708, 710 and 712, respectively, described in connection with FIG. 4, with light emitting device 608 emitting light pulses 630 during operation. The predominate difference between circuit 700 of FIG. 7 and circuit 800 of FIG. 8 is that circuit 800 includes an additional substrate 824 and window 828 configured to provide a hermetic package to protect the light emitting device 808. Reduced inductance may be achieved using the same techniques described earlier herein.

The second substrate 824 is placed over the components mounted on the top side of the substrate 802. The optical window 628 is placed over the ends of the substrate 802 and second substrate 824. This forms a hermetic seal over the light emitting device 808. In some configurations, the low inductance foil conductors 716, 722 are replaced with low inductance metal traces on the separate substrate 824, matched to make electrical connections to the respective components.

FIG. 9 is a top perspective schematic view of a sixth exemplary component configuration for a pulsed light circuit 900. This configuration illustrates another example physical layout for any one of the circuits 10, 100, and 200 that is designed to reduce inductance in the driver circuit supplying power to the light emitting device. The circuit 900 may implement elements of the circuits 10, 100, and 200 disclosed herein, respectively, and operate as described above in connection with those circuits. The circuit 900 differs from previously disclosed configurations primarily in that it uses thru vias 932, 934 (shown in FIG. 11) passing through the substrate 902, instead of metal foil wrapped around the ends of the substrate, to provide current paths between the top and bottom sides of the substrate 902. Reduced inductance may be achieved using the same techniques described earlier herein.

As shown in FIG. 9, the circuit 900 includes a generally planar substrate 902 having a top side and a bottom side. Two supply capacitors 904, 905 are mounted to the top side of the substrate 902, diodes 906, 907 are also mounted to the top side of the substrate 902, and a light emitting device 908, such as an edge emitting device described earlier herein, is also mounted to the top side of the substrate 902 and may emit light pulses 930 in a generally horizontal direction relative to the substrate 902.

Conductors 913, 914 connect the capacitor(s) 904, 905 to the diode(s) 906, 907. The conductors 913, 914 can be a metal strap 914 or foil, as described herein, and layer 913 on or within the substrate 902. Conductors 916, 917 connect the diode(s) 906, 907 to the light emitting device 908. The conductor 916 can be a metal trace bonded to the diodes 906, 907 and the conductor 917 can be a metal contact formed to connect the trace 916 and the light emitting device 908. Diodes 901, 903 are connected to the conductor 918 and to the conductor 916 by metal strap or foil. Conductor 918 is formed on or within the substrate 902 to provide a current path between the light emitting device 908 to the resistor block 910 by one or more vias 932 (FIG. 11).

The substrate 902 may be a co-fired ceramic substrate, for example, a high temperature co-fired ceramic (HTCC) substrate. The thickness of the substrate 902 may be kept relatively thin to reduce inductance. For example, the thickness of the substrate 902 may be 4 mils or less. The substrate 902 may have conductive layers formed only along its surfaces. Alternatively, the substrate 902 may be a multilayer substrate with conducting layers, such as metal layers, formed internally within itself and on its surfaces.

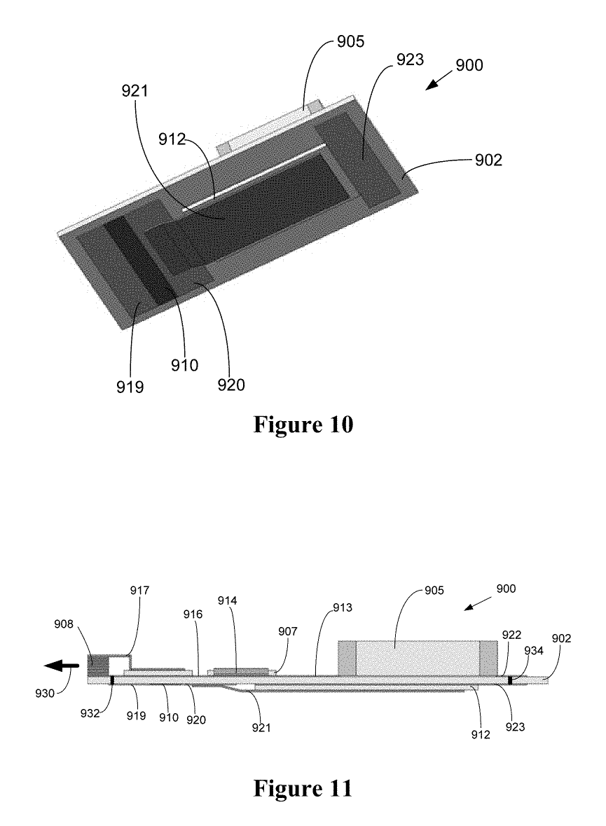

FIG. 10 is a bottom perspective schematic view of the pulsed light circuit 900. A resistor block 910 and a solid-state switch 912 are mounted to the bottom side of the substrate 902. Conductor 919, which may be a metal pad formed on or within the substrate 902, provides a current path between the light emitting device 908 and resistor block 910 by way of via(s) 932. Conductor 920, which may be a metal pad formed on or within the substrate 902, is connected to metal strap 921, which together provide a current path between the resistor block 910 and the switch 912. Conductor 923, which may be a metal pad formed on or within the substrate 902, provides a current path between the switch 912 and capacitors 904, 905 by way of via(s) 934 and metal pad 922 (shown in FIG. 11).

The components 904-908, 910 and 912 can be the same as those described in connection with FIGS. 1, 2, and 3, respectively, with the light emitting device 908 being an edge emitting device described earlier.

FIG. 11 is a side cross-sectional schematic view of the pulsed light circuit 900.

The conductors 914-923 may be relatively thin and wide to reduce inductance. For example, one or more of the conductors 914-923 may be five skin depths or less in thickness with respect to the resonant frequency of the power conversion circuit.

All of the components shown in FIGS. 9-11 may be surface mount components and the semiconductor components and/or other electrical components may be unpackaged, bare die devices that can be flip-chip mounted, directly wire bonded to the substrate 902, or bonded to conductive foil. The use of unpackaged components may reduce the inductance of the circuit.

Each of the circuit modules illustrate in FIGS. 4-11 may be physically compact, measuring about 30 mm wide×35 mm length×10 mm height. Also, other configurations of the driver circuit can use combinations of vias, metal foil and/or straps to provide a low-inductance supply current path between the various electrical components of the circuit.

One or more of the circuits 10, 100, 200, 400, 500, 600, 700, 800, 900 disclosed herein can be included in a 3D imaging system as an illuminator, light source, illumination subsystem or component thereof, or the like. For example, each of the disclosed circuits may be included as an illuminator, light source, illumination subsystem or component thereof in any of the 3D imaging systems disclosed in U.S. patent application Ser. No. 15/823,482, entitled “System and Method of Reducing Ambient Background Light in a Pulse-Illuminated Image,” filed Nov. 27, 2017 (“'482 application”), which is incorporated by reference in its entirety as if fully set forth herein. A 3D imaging system may include more than one of the pulse circuits as a light source. In 3D imaging applications, the pulse circuits 10, 100, 200, 400, 500, 600, 700, 800, 900 can be used to produce one or more illumination pulses for illuminating a scene of interest. The controller, processor subsystem, processor or other control means of the 3D imaging system, such as any of those systems disclosed in the '482 application, may be configured to control the operation of the pulse circuit, for example, by generating the control trigger signal input or other input to the pulse circuits disclosed herein to control and time emissions of the illuminating pulses from the circuit. For example, the 3D imaging system may control the included pulse circuit(s) so that it emits illumination pulse sequences and timing as described in the '482 application.

The pulse circuits 10, 100, 200, 400, 500, 600, 700, 800, 900 may also be included in LIDAR systems for measuring distances to objects in a scene by illuminating those objects with a pulsed laser light and then measuring the reflected pulses with a sensor. Differences in laser return times can be used to make digital 3D-representations of the target scene. The LIDAR embodiments of 3D imaging systems are useful in automotive applications, particularly using one or more of the systems as a sensor on an autonomous vehicle to detect and sense objects and their positions around the vehicle. In such an application, one or more of the systems can be mounted on the vehicle to cover fields of view around the vehicle. The systems can detect objects and their positions around the vehicle in real-time as the vehicle moves along roadways and in traffic. The LIDAR embodiments of the systems may be useful for other applications, such as robotic vision, surveying, video game controls, visual effects, augmented-, mixed-, virtual-reality or similar, mapping, handheld devices such as cameras, smartphones, or the like, and other applications where it is useful to know coordinate or location information about areas of the real-world.

It should be understood that, depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially. In addition, while certain aspects of this disclosure are described as being performed by a single module or component for purposes of clarity, it should be understood that the techniques of this disclosure may be performed by any suitable combination of components or modules associated with a pulsed driver circuit.

The foregoing description is illustrative and not restrictive. Although certain exemplary embodiments have been described, other embodiments, combinations and modifications involving the invention will occur readily to those of ordinary skill in the art in view of the foregoing teachings. Therefore, this invention is to be limited only by the following claims, which cover one or more of the disclosed embodiments, as well as other such embodiments and modifications when viewed in conjunction with the above specification and accompanying drawings.

What is claimed is:

1. A circuit for providing pulsed power to a solid-state light emitting device, the circuit comprising:
a plurality of electrical components, wherein at least one of the components is a bare die; and
at least one electrical conductor connecting the components, the conductor being configured to carry current to power the solid-state light emitting device and to reduce inductance of the circuit.

2. The circuit of claim 1, wherein the electrical components include a MOS gated thyristor (MGT).

3. The circuit of claim 1, further comprising a substrate having a first side opposing a second side, wherein the components are mounted to the substrate; and wherein the electrical conductor includes a first portion located on or over the first side of the substrate and a second portion located on or over the second side of the substrate, the first portion being configured to carry the current in a first direction and the second portion being configured to carry the current in a second direction opposite to the first direction so as to reduce inductance of the circuit.

4. The circuit of claim 3, wherein the substrate is a co-fired ceramic substrate.

5. The circuit of claim 4, wherein the substrate is a high temperature co-fired ceramic (HTCC) substrate.

6. The circuit of claim 1, wherein the electrical conductor is a metal foil.

7. The circuit of claim 1, wherein the electrical conductor is a metal selected from the group consisting of copper, silver, gold, silver-plated copper, and any suitable combination of the foregoing.

8. The circuit of claim 1, wherein the electrical conductor has a thickness of five skin depths or less, based on the self-resonant frequency of the circuit.

9. The circuit of claim 1, wherein the electrical conductor is a metal layer formed on a substrate.

10. The circuit of claim 1, further including the solid-state light emitting device, wherein the solid-state light emitting device is selected from the group consisting of a laser diode, a light emitting diode (LED), a vertical surface cavity emitting laser (VCSEL), an edge emitting laser diode, one or more bars of laser diodes, one or more arrays of VCSELs, one or more arrays of LEDs, and any suitable combination of the foregoing.

11. The circuit of claim 1, wherein the current is 4000 amps or more.

12. An apparatus for providing pulsed power to a solid-state light emitting device, comprising:
a planar substrate having a first side opposing a second side;
one or more first electrical components mounted on the first side of the substrate;
one or more second electrical components mounted on the second side of the substrate, wherein at least one of the first electrical components or second electrical components is a bare die;
at least one conductor, connecting the first electrical components and the second electrical components, for carrying current to power the solid-state light emitting device, wherein the conductor includes a first portion located on or over the first side of the substrate and a second portion located on or over the second side of the substrate, the first portion being configured to carry the current in a first direction and the second portion being configured to carry the current in a second direction opposite to the first direction so as to reduce inductance of a circuit carrying the current.

13. The apparatus of claim 12, wherein the conductor includes a plurality of metal layers formed on the substrate and one or more vias through the substrate providing a current path between the metal layers.

14. The apparatus of claim 12, wherein the conductor includes metal foil connecting the first and second portions of the conductor.

15-19. (canceled)

20. A method of generating pulses of current for driving a solid-state light emitting device, comprising:
providing at least one capacitor as part of a circuit for providing current to the solid-state light emitting device;
providing at least one electrical conductor connecting the capacitor to one or more other components of the circuit, the conductor being configured to carry the current for powering the solid-state light emitting device and to reduce inductance of the circuit;
providing a switch for controlling flow of the current through the circuit; and momentarily closing the switch so that the current flows through the solid-state light emitting device.
